(19) United States
(12) Patent Application Publication
(10) Pub. No.: US 2002/0143878 A1
(43) Pub. Date: Oct. 3, 2002

(54) Collaboration between two computing devices

(75) Inventors: Bradley S. Birnbaum, Muttontown, NY (US); Arthur A. Lussos, Port Jefferson Station, NY (US); Sam Wen, East Setauket, NY (US)

Correspondence Address: TROUTMAN SANDERS LLP, BANK OF AMERICA PLAZA, SUITE 5200, 600 PEACHTREE STREET , NE, ATLANTA, GA, 30308-2216, US

(73) Assignee: Inventions, Inc., Norcross, GA (US)

(21) Appl. No.: 10/107,632

(22) Filed: Mar. 27, 2002

Related U.S. Application Data
(60) Provisional application No. 60/279,380, filed on Mar. 28, 2001.

(51) Int. Cl. G06F 15/16

(52) U.S. Cl. 709/205

(57) ABSTRACT

A first computing device and a second computing device establish (101) a connection and the first computing device downloads (102) a mini-application which monitors for changed information on the first computing device, such as a new web page address or information entered into the field of a form displayed on the browser of the first computing device. Once the mini-application detects (103) such a change it sends (104) the information regarding the change to the second computing device. The second computing device then implements (105) that information by acting on or displaying that information, such as by going to the new web page address if the change was a new website, or by displaying the information in the appropriate field on the form displayed on the second computing device. The mini-application continues (106) to monitor for change on the first computing device until web collaboration is disabled (107).

### PRIORITY CLAIM

This patent application claims the priority of U.S. Provisional Patent Application Serial No. 60/279380 filed Mar. 28, 2001, entitled “Collaboration Between Two Computing Devices”.

### FIELD OF THE INVENTION

This invention relates to Internet technologies, and more particularly, for providing collaborative web browsing and form completion between two remote computing devices.

### BACKGROUND OF THE INVENTION

Many companies have web sites which allow customers to obtain information about products and services, apply for credit with the company, order products and services, etc. Some customers are very capable and have no trouble maneuvering within very complicated or even poorly designed web sites. Other customers are inexperienced or have difficulty with any web site, even if carefully designed. A web site designed to accommodate the lowest skill level would often be viewed as slow and cumbersome by an Internet-skilled customer, whereas a web site designed for the Internet-skilled customer would often be viewed as unmanageably complex by a customer with low skill levels. Therefore, many web sites are designed as a compromise which allows the skilled customer to quickly achieve the desired result and which provides more assistance for a customer with lesser skills.

However, many customers may still have problems, regardless of how well-designed or poorly-designed the web site may be. The customers may be unable to find information that is on the web site or may need assistance in completing forms on the web site. Some of these customers may require the “hands-on” assistance of an agent of the company. Unfortunately, the customer and the company agent are often separated by hundreds or thousands of miles, so “hands-on” assistance is not physically possible.

Training presents another challenge. If a new person is being trained on a computing device, or a person is being trained on a new program, the trainer and the trainee generally have to be in the same room, or close by, in order that the trainer can see what the trainee has done and instruct the trainee how to properly perform the task at hand. However, some large companies have offices in which the trainer and trainee are separated, such as being in different cities, counties, states, or countries.

In cases where the agent or trainer cannot see the screen of the customer or trainee, assistance is often difficult, if not impossible, because the agent/trainer must rely upon the customer/trainee verbally describing what is present on the screen of the customer's/trainee's computing device. Often, the customer/trainee is ill-equipped to perform this task, or an erroneous entry has called-up a screen which the agent/trainer is unable to identify from the verbal description provided by the customer/trainee.

In limited circumstances, the prior art allows a person, such as an agent or trainer, to give “virtual” hands-on assistance to another person, such as a customer or trainee. In the prior art, the first computing device, being used by the customer or trainee, and the second computing device, being used by the agent/trainer, are connected via a network, which may be any convenient network, such as a local area network or a wide area network, such as the Internet. The agent, at the second computing device can see, on the screen of the second computing device, the very same display on the screen of the first computing device that is seen by the customer. Further, both the agent/trainer and the customer/trainee can control the operation of the first computing device. One example of prior art which provides this capability is “PCAnywhere” by Semantec Corporation. “PCAnywhere” is a trademark of Semantec Corporation.

However, the solutions provided by the prior art is generally expensive and requires a substantial amount of memory in both computing devices. The cost alone prohibits most people from utilizing the prior art, especially since Internet shopping is expected to be free. The memory requirements can present a problem in some computing devices, especially some of the low-cost computing devices which are often memory-limited. Further, even if both users were willing to pay the cost of the prior art and had requisite computing device capabilities, the users at both computing devices must anticipate the need for the collaboration and purchase the software required for collaboration. Most users do not anticipate the need for such prior art software so they would have to order the prior art software, wait for delivery, and then install it. However, most users are not willing to wait for this amount of time, so they will switch to another company whose web site is more convenient, or they will abandon the attempt entirely. Ordering and/or downloading the software via the Internet may be somewhat faster, but this option is not available if the customer is already having a problem trying to search for a product or service or place an order via the Internet. In other words, if the customer could place an order via the Internet the customer would not need the software to help the customer place an order via the Internet.

Another factor is that many users will have little or no other use for such prior art software, and so they are unwilling to spend the money to acquire the prior art software or time installing and setting-up the prior art software.

In addition, as indicated above, the prior art software allows the agent to directly control the customer's computing device, just as if the agent were present at the customer's computing device and actually typing in commands at the customer's computing device. Thus, the customer is dependent upon the trustworthiness of the agent because the agent, at the second computing device can directly control the customer's computing device. Thus, an incompetent or malicious agent could alter or damage files and programs in the customer's computing device and even to an internal office network, commonly referred to as an intranet. In many cases this level of access and control by the second user, the agent, is not necessary to accomplish the task at hand and will not be permitted by the customer for obvious security reasons.

Thus, allowing another person unfettered access and control to all programs and files on a user's computing device, the added memory requirements and the cost of such prior art programs, the need to anticipate the need for the prior art software and obtain it prior to actual need for it, and the lack of other need for the prior art software, are all disadvantages of the prior art. As a result of these disadvantages, the customer may become dissatisfied with the assistance provided or the lack of assistance, or with the time, expense and/or difficulty involved in obtaining assistance, and so present and future sales may be lost. Further, a trainee may be improperly trained, or may become frustrated with the training process and decide to learn by trial and error, which is inefficient and may lead to the loss of valuable data or customers.

### SUMMARY OF THE INVENTION

These and other problems of the prior art are overcome by the present invention. The present invention provides for collaboration between two computing devices so that a person at one computing device sees the same information as a person at another computing device. Briefly stated, a first computing device is monitored for changes and the changes are sent to the second computing device, wherein they are implemented by the second computing device, such as by displaying, presenting, or otherwise acting on the changes.

The present invention provides a method of operating a first computing device and a second computing device including connecting a first computing device and a second computing device, monitoring for predetermined changes at the first computing device, sending information regarding the predetermined changes to the second computing device, receiving the information at the second computing device, and implementing the information at the second computing device.

The present invention also provides a method of operating a first computing device including connecting the first computing device to a second computing device, monitoring for predetermined changes at the first computing device, and sending information regarding the predetermined changes to the second computing device.

The present invention also provides a method of operating a first computing device including connecting a first computing device to a second computing device, receiving, at the first computing device, information regarding predetermined changes at the second computing device, and implementing the information at the first computing device.

The present invention also provides a method of operating a first computing device including connecting a first computing device to a second computing device, monitoring for predetermined changes at the first computing device, sending the information regarding the predetermined changes to the second computing device, receiving at the first computing device the information regarding the predetermined changes at the second computing device, and implementing at the first computing device the information regarding the predetermined changes at the second computing device.

The present invention also provides a method of operating a first computing device including connecting a first computing device to a second computing device, monitoring for predetermined changes at the first computing device, sending information regarding the predetermined changes to the second computing device, receiving information regarding the predetermined changes at the second computing device, comparing the information regarding the predetermined changes at the first computing device with the information regarding the predetermined changes at the second computing device, and implementing at the first computing device the information regarding the predetermined changes at the second computing device which is different from the information regarding the predetermined changes at the first computing device.

The present invention also provides for transferring a program to a computing device, the program being for monitoring for the predetermined changes at that computing device.

The present invention also provides for monitoring for predetermined changes at a computing device by monitoring for changes relating to a predetermined program operating on that computing device.

The present invention also provides that monitoring for predetermined changes at a computing device may include monitoring for changes relating to a web browser program operating on that computing device.

The present invention further provides that monitoring for predetermined changes at a computing device may include monitoring for a change in an Internet web address used by a web browser program operating on that computing device.

The present invention further provides that monitoring for predetermined changes at a computing device may include monitoring for user input to a form displayed by a web browser program operating on that computing device.

The present invention further provides that monitoring for predetermined changes at a computing device may include monitoring for a new cookie received by a web browser program operating on that computing device.

The present invention further provides that implementing the information at a computing device may include entering the information into a predetermined program operating on that computing device.

The present invention further provides that implementing the information at a computing device may include entering the information into a web browser program operating on that computing device.

The present invention further provides that implementing the information at a computing device may include entering the information into the Internet web address portion of a web browser program operating on that computing device.

The present invention further provides that implementing the information at a computing device may include entering the information into a form displayed by a web browser program operating on that computing device.

The present invention further provides that implementing the information at a computing device may include storing a new cookie in a file related to a web browser program operating on that computing device.

The present invention further provides that monitoring for predetermined changes at a computing device may include inspecting that computing device for the predetermined changes at predetermined intervals.

The present invention further provides that, after receiving the information at a computing device, optionally presenting the information to a user at that computing device for approval and, if the user approves the information, then implementing that information.

The present invention further provides that connecting the computing devices may include communicating through a server that interacts with at least one of the computing devices.

The present invention also provides that a second person, such as an agent or trainer, at the second computing device, has limited access to a first computing device, such as the customer's or trainee's computing device.

In addition, the present invention provides for reducing the memory requirements of the software to be installed on the customer's computing device.

Also, the present invention reduces the cost to the customer of the necessary software. Although the company may, if desired, charge for the product or the service, the present invention allows the software to be provided for free.

Further, the present invention eliminates the need for the customer to obtain the software prior to the time when it will actually be used.

Further, in some cases, the second computing device only needs access to one program on the first computing device. Therefore, the present invention also provides for limited access to a specified program on the first computing device. In the preferred embodiment of the present invention, the access of the second computing device is limited to a web browser program running on the first computing device.

In addition, the present invention provides that the user of the second computing device has strictly limited access to the first computing device. The second computing device user does not directly see the display of the first computing device, but can only receive and display predetermined information from the first computing device, such as new web addresses, text entries, messages and/or cookies. The present invention further provides that the user at the second computing device cannot directly control the first computing device but can only send predetermined information to the first computing device, such as new web addresses, text entries, messages and/or cookies. Therefore, in the preferred embodiment, other programs, files, documents, and information, on the first computing device are kept out of reach and are invisible to the agent at the second computing device.

The present invention thus provides for collaboration between the two computing devices, preferably, but not necessarily, limited to collaboration between the web browser programs running on the two computing devices. Browser collaboration provides for the first computing device and the second computing device to display the same web pages on the browsers on both computing devices. The sending computing device, such as the first computing device, pushes the predetermined information on its browser to the browser on the second computing device.

A “computing device” may be any type of device that has the ability to display information and perform computing functions including, but not limited to, computers, personal computers, “Palm” devices, Personal Digital Assistants (“PDAs”), laptops, desktops, terminals, cellular phones, mobile phones, handheld devices, personal organizers, personal web search devices, etc.

Another embodiment of the present invention, namely a forms assistant feature, provides for the user at the first computing device to input information to fill out or complete or modify a form present on the first computing device's browser. The first computing device then sends this input information to the second computing device, the second computing device receives this information from the first computing device and then inserts this information into that same form, which is also present on the second computing device. The user at the first computing device and the user at the second computing device can therefore collaboratively complete a form by the first computing device polling for new information entered at the first computing device, and communicating any new information to the second computing device. This helps agents to assist customers by enabling the agent to view what is present on the user's web browser and by viewing what a user is entering into a form on the browser.

The term “form” is used in an inclusive sense, and is not limited to a conventional form which has a blank for a person to enter his/her name, or a block to be checked “yes” or “no”. Rather, the term “form”, while including the example above, also includes anything that may be presented by a computing device and sensed and responded to by the user. For example, a form may be, or may include, a drawing, diagrams, an art work, a game, a video, a sound, music, a smell, or a taste, or a combination of the above, including multiple occurrences of the above. The present invention thus allows the agent and customer to collaborate regardless of the type or manner of form being used.

In addition, the present invention, by the use of cookies, allows the agent and customer to independently visit the same web page so that each independently receives the same information from the connected server. When the customer visits a web site, the server at that site will send a cookie to the customer's computing device. The present invention provides for forwarding that web address and that cookie to the agent's computing device. Thus, when the agent visits that web site, the agent's computing device will provide the same cookie to the server, and thus the customer's computing device and the agent's computing device will be perceived as being the same computing device, so the customer and the agent will be connected to the same web page and see the same information or form.

The present invention therefore allows an agent or a trainer to conveniently and remotely assist a customer or a trainee because the agent or trainer can indirectly see what the customer or trainee is seeing, to indirectly see what the customer or trainee is doing or typing in, to indirectly see what web address or page the customer or trainee is on, and the agent or trainer can send information to the customer or trainee.

### BRIEF DESCRIPTION OF THE DRAWINGS

FIG. 1 is a flow chart of the preferred process of the present invention.

FIGS. 2A and 2B are a flow chart of the preferred process performed by the customer's computing device.

FIGS. 3A and 3B are a flow chart of the preferred process performed by the agent's computing device.

FIG. 4 is an illustration of the polling operation.

FIG. 5 is a block diagram of a computing device in accordance with the present invention.

### DETAILED DESCRIPTION

Referring now to the figures in which like numerals refer to like elements throughout the several views, various embodiments and various aspects of the present invention are described. Although the present invention is described as embodied within a first computing device and second computing device connected via the Internet, those skilled in the art will appreciate that the present invention may be used in conjunction with a local area network, or any other network which would support such a connection.

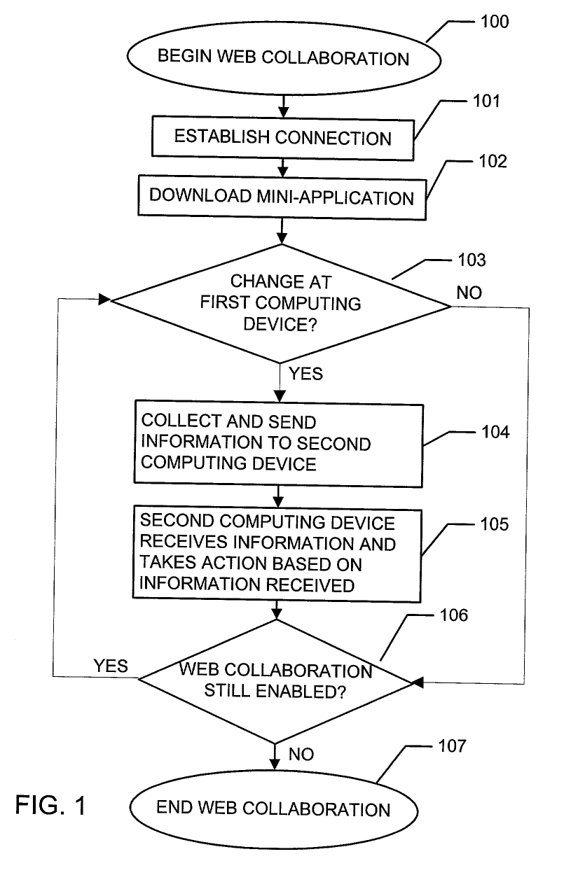

FIG. 1 is a flow chart of the preferred process of the present invention. To begin web collaboration 100 between a first computing device and a second computing device, a connection between the computing devices is established 101 which, in the exemplary embodiment, is via the Internet. However, the connection may be of any desired kind, or via any desired network, which will provide for the transfer of the desired information in an acceptable manner considering such factors as cost, security, speed, etc. The connection may therefore be, for example and not by way of limitation, via the Internet, an Intranet, sonic, optical, wireless, wired, satellite, infrared, etc.

In the exemplary embodiment, after the connection is established, a mini-application is downloaded 102 to the first computing device. The mini-application is a small software module such as a Java Applet or an Active X Control that resides on the first computing device. The mini-application may remain on the first computing device indefinitely for future web collaboration or may be downloaded to the first computing device every time web collaboration is initiated. The mini-application contains instructions to enable web collaboration.

For ease of description, the term agent should be understood as including both agent and trainer, and that the term customer should be understood as including both customer and trainee, as determined by and appropriate for the particular environment being discussed.

When the mini-application is initiated or running, the first computing device may lead and the second computing device will follow, the first computing device may follow and the second computing device will lead, or both computing devices may both lead and follow. Whether a computing device leads or follows may be predetermined or may be specified by the agent at the second computing device or by the customer at the first computing device. For example, the default setting may be that the first computing device leads and the second computing device follows. Whether the agent or the customer controls this selection is a design choice. Typically, the agent will be the person who is in the better position to make an informed decision. Also, this selection may be fixed throughout a session, or may be changed at any time during a session. For example, the first (customer's) computing device may initially be designated to lead. However, after assisting the customer, the agent may determine that it would be better for the second (agent's) computing device to take the lead, so the agent may send a command to the second computing device to lead, and to the first computing device to follow. This may be accomplished by a menu pull down, an icon, or any other desired technique. Likewise, if the customer has the option, or is given the option by the agent, of selecting which computing device leads or follows, the customer may send the command in a similar manner using a similar technique.

If the first computing device leads, the first computing device will be periodically polled (discussed below) for changes and those changes will be sent to the second computing device. Alternatively, if the first computing device follows, the second computing device will be periodically polled for changes and those changes will be sent to the first computing device. If both computing devices lead, then both computing devices will be periodically polled and the changes on one computing device will be sent to the other computing device. For convenience below in describing the operation of the present invention, the first computing device has been designated to lead.

The mini-application monitors 103 the first computing device for changes. If no changes are detected, then the mini-application proceeds to step 106. If a change in the browser on the first computing device is detected, then the mini-application collects 104 the change or changes and sends 104 the information about these changes to the second computing device.

The second computing device then receives and implements 105 the new information. The second computing device implements the information by acting on or displaying that information. For example, if the new information was a web address, then the second computing device may go to that web address. If the new information is information in a particular field of a form, that information will appear on the second computing device's display in the appropriate field of the same form.

If, at step 106, web collaboration is still enabled then the process continues by returning to step 103. This process continues until web collaboration is terminated 107. Termination may be caused by the user at the first computing device, the user at the second computing device, a server connected to either computing device, a change in the web page on the browser of one of the computing devices, the passage of time, or any other desired criteria.

Although step 106 is shown as appearing after steps 103-105, it could appear before any or all of them, or could appear multiple times, such as between each step, so that confirmation of web collaboration enablement is made before information is sent or received.

Generally, the user at the first computing device will be the customer, the first computing device will be the customer's computing device, the user at the second computing device will be the agent, and the second computing device will be the agent's computing device. However, information regarding the changes may flow in either direction, as desired, so that changes on the customer's screen will show up on the agent's screen or, if the agent is taking the lead, changes on the agent's screen will show up on the customer's screen, or at least a message regarding those changes will show up on the customer's screen.

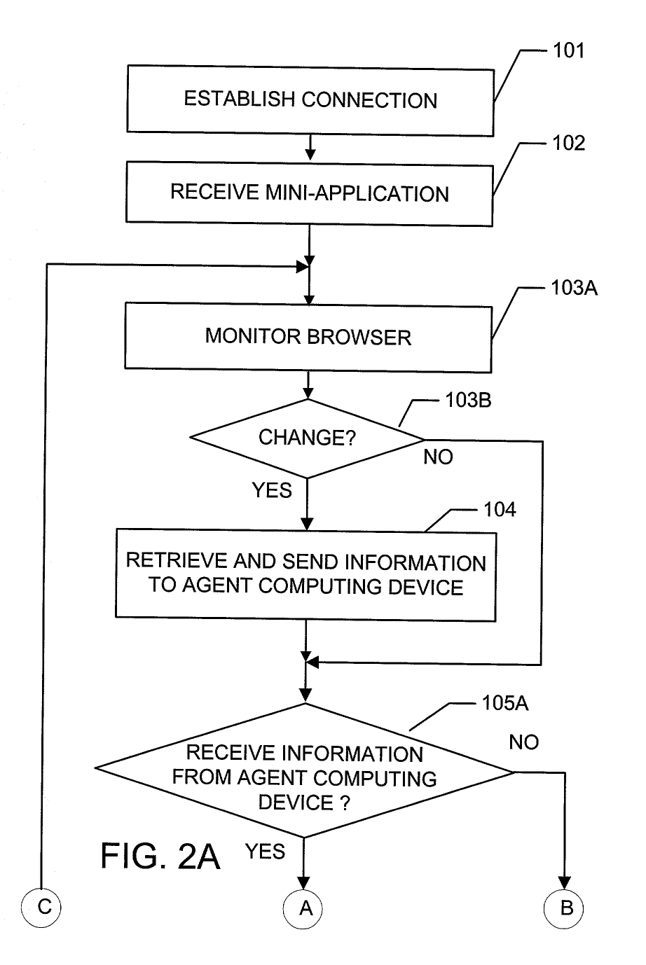

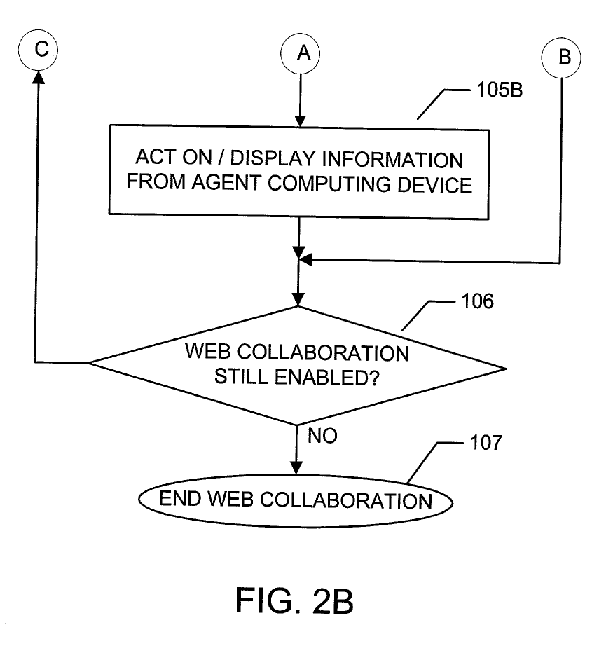

FIGS. 2A and 2B are a flow chart of the preferred process performed by the customer's computing device. To commence collaboration between the customer's computing device and the agent's computing device, a connection is established 101 between the customer's computing device and a company computing device, such as the web server, the agent's computing device, or some other computing device designated to accept a request for a connection by the customer. The customer's computing device may actually be connected to a company server that then interacts with an agent's computing device. The same may be true on the customer side, in that numerous customer computing devices may be connected through one customer server that controls and interacts with the customer computing devices. However, for ease of discussion the connection with the agent through or not through a company server shall be referred to as a connection to the agent's computing device, and a connection with the customer through or not through a customer server shall be referred to as a connection to the customer's computing device. It will be appreciated that a single server can control and service numerous connections and computing devices. In the preferred embodiment, this connection is via the Internet. This connection may be established automatically, such as when the customer visits the web site, or visits a particular web page, such as a helpdesk web page, or requests assistance. The connection may also be established manually, such as when the user is advised that an agent is available to assist and the user is asked to agree to accept a mini-application to allow the agent to assist the customer, and the user clicks on an “I accept” box (not shown).

Once the connection is established 101 between the customer's computing device and the agent's computing device, the customer's computing device receives (downloads) 102 a mini-application containing instructions to enable collaboration between the customer computing device and the agent computing device. The mini-application may be downloaded from the second computing device, may be downloaded from the server for the second computing device, or may be downloaded from any host or server which is connected to the first computing device. Once the mini-application is downloaded, it is installed and begins operation on the first computing device.

In the preferred embodiment, the mini-application is downloaded automatically when the customer requests assistance, such as by clicking on a “HELP” icon (not shown), clicking or replying “YES” (not shown) in response to a question as to whether the customer needs assistance, or clicking on the “I accept” box (not shown). In alternative embodiments, this may done by other methods, whether automatic or at the instance of the customer or the agent. For example, downloading may be caused by the customer logging on to the company web site, or by the customer going to a specific web page and selecting the mini-application, or by the agent sending the mini-application to the customer to activate or install, or by the agent causing the company server to send the mini-application to the customer, or by any other convenient method.

Once the mini-application is downloaded onto the customer computing device it automatically installs itself and begins operation. In an alternative embodiment, the customer may have to click on the mini-application, or open the mini-application, or take some other action to cause the mini-application to be installed and begin operating.

There are two phases to the operation of the mini-application: sending and receiving. The sending phase is concerned with detecting changes on the customer's computing device and sending the changes to the agent's computing device; the receiving phase is concerned with receiving changes from the agent or the agent's computing device and implementing those changes.

For the sending phase, the mini-application monitors 103A activity on the customer computing device. In the preferred embodiment, the mini-application monitors for predetermined changes in the web browser program on the first computing device. A predetermined change may be any change in the browser program or related files which it is desired to detect and monitor. Such changes preferably include, but are not limited to, user input (clicking on a mouse, typing, hitting a key, entering information into a form, etc.), a new web address (whether provided by the user or pushed down by the web site), a new or modified cookie, etc. However, the mini-application may monitor any desired activity of any program. Where information is being entered into a form or a web page by the user, “screen scraping” may be used to extract the changes. Examples of the implementation and use of screen scraping are provided in the following U.S. Pat. Nos. 5,437,014; 5,675,637; 5,761,494; and 5,784,610.

In the preferred embodiment this monitoring activity is accomplished via a polling action, which occurs every 2 seconds. Other polling intervals may be used, but polling too frequently unnecessarily uses computing device time and network bandwidth, and polling too infrequently causes unnecessary delays in the agent being able to see what the customer is seeing or doing, and thereby delays the agent in being able to assist the customer. An excessive delay can be irritating to both the customer and the agent. Thus, a polling interval in the range of 2 to 8 seconds is preferable.

If, at step 103B, a change in browser activity on the customer computing device is detected then information regarding the change is collected and sent 104 to the agent's computing device. The information regarding the change may be the new information entered by the customer or received since the last polling time, such as a new web address present on the browser of the first computing device, a cookie received by the first computing device, new information entered on the first computing device's browser by the user, information entered into a form by the user, etc. Alternatively, all of the information on the screen may be sent.

If information from different fields on a form or a web page is to be sent then the information in one field is preferably separated from the information for another field by any desired unambiguous character, such as a “tab” character. A blank field, or a field where there is no change, may be indicated by two consecutive tab characters, or by two tab characters separated by a “null” character. However, the desired character may be any character which does not adversely affect the operation of the monitored program or computing device.

Once the information is sent then step 105A is executed.

If, at step 103B, a change in browser activity on the customer computing device is not detected then step 105A is executed.

Step 105A monitors for information sent by the agent's computing device. This information is preferably the same type of information as that monitored for in step 103A, but may be only a subset of the information, or may be different information, depending upon the particular functionality desired. If information has not been received then step 106 is executed.

If information has been received from the agent's computing device then step 105B is executed. In step 105B the customer's computing device implements the information by acting on that information, displaying that information, or both. For example, if the agent has sent a message, then the message will be presented to the customer. If the agent has sent a cookie, that cookie will be installed on the customer's computing device. If the agent has sent a new web address, that new web address will be installed on the browser and then the browser will request a connection to that new web address. If the agent has entered information into a form on the agent's computing device, that information will appear on the form on the customer's computing device. If desired, such as with respect to cookies, form entries, or new web addresses, the receipt of such information may cause a message to appear regarding the information received and the customer asked whether the information should be acted on or not.

Steps 105A and 105B are optional. Further, even if they are performed, they may only be performed in part. For example, if it is only desired that the agent be able to send a message to the customer, then the mini-application may provide the capability to receive and display the message. However, if both the customer and the agent have “instant messaging” capability on their computing devices or are “chatting”, then the mini-application need not provide for messaging capability.

In step 106 a determination is made as to whether web collaboration is still enabled. If web collaboration is still enabled, then step 103A is executed again. If web collaboration is no longer enabled, then web collaboration is ended at step 107.

As mentioned above, although step 106 is shown as appearing after steps 103A-105B, it may appear in a different location, or may appear multiple times, in different locations.

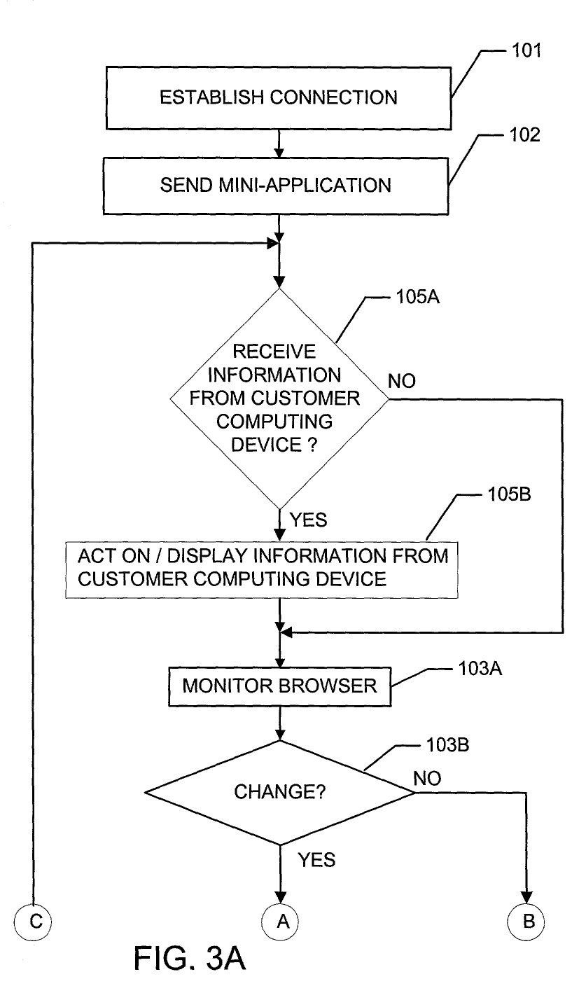

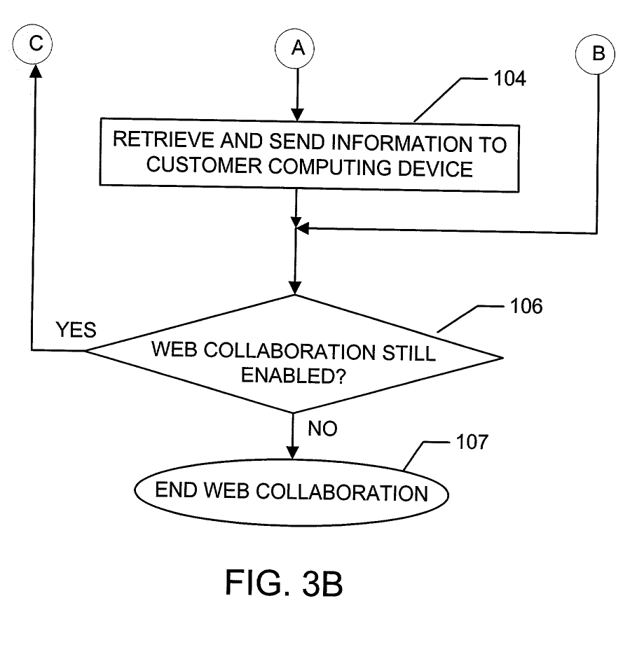

FIGS. 3A and 3B are a flow chart of the preferred process performed by the agent's computing device. In general, the operation of the agent's computing device is similar to the operation of the customer's computing device.

As mentioned above, to commence collaboration between the customer's computing device and the agent's computing device a connection is established 101 between the customer's computing device and a company computing device.

Once the connection is established a mini-application is sent 102 to the customer's computing device. As mentioned above, the mini-application may be sent on demand by the agent, or may be sent in response to some other occurrence, such as logging on, as mentioned above. Once the mini-application is sent to the customer computing device, installed thereon, and activated, it will monitor for and send changes to the agent's computing device, as described with respect to FIGS. 1 and 2. The agent's computing device has a similar program installed or running. In the case of the agent's computing device, this program may be permanently installed, may be installed when the agent is assigned to customer assistance operations, or may be installed when the agent is connected to a customer. Also, in the case of the agent's computing device, this program may be a mini-application, may be a larger application with more features or capabilities, or may be part of the operating system on that computing device.

At decision 105A the agent's computing device determines whether it has received any information from the customer's computing device. If not, step 103A is executed. If information has been received then, in step 105B, this information is implemented, such as by being acted on or displayed. Whether the information is acted on or displayed is a design choice based upon the company's requirements. The agent's computing device may be programmed to automatically display, but not act on, any information so that the agent can determine whether the information should be acted on and then indicate approval or disapproval. The agent's computing device may also be programmed to automatically act on any information without requiring agent approval. The agent's computing device may also be programmed to automatically act on certain information, such as form entries made by the customer, but to require agent approval for other information, such as a new web site or a cookie.

If the information is to be acted on, then the action taken will depend upon the nature of the information received. If the customer has entered information into a form or into a particular field on a form, and that is the information that was sent, then the agent's computing device will display the form and the information that has been entered in that field on the form. If the information is a new web address, the browser on the agent's computing device will go to that new web address. If the information is a new cookie, the browser on the agent's computing device will store that new cookie. Thus, any change occurring at the customer's browser will also occur at the agent's browser, so the agent's browser will be synchronized to the customer's browser. A new cookie is preferably stored only temporarily. The cookie may be automatically deleted when web collaboration is ended, deleted when the agent's computing device is turned off, deleted after a certain amount of time, deleted at a predetermined time, or deleted in accordance with any other desired procedure. Alternatively, the agent may be asked, such as via a pop-up reminder, or a via a log-off procedure, or via any other procedure, whether to keep the cookie or delete it.

The agent computing device may also monitor 103A for certain types of changes. For example, the agent may type in a web address, or type an entry into a form, or a cookie may be received from a web site. The program in the agent's computing device preferably distinguishes between changes caused by information sent by the customer's computing device and changes caused by another source. This limitation prevents a change at the customer's computing device from triggering a change at the agent's computing device which triggers a change at the customer's computing device, etc.

If there is a change then the agent's computing device retrieves and sends 104 the information to the customer's computing device. Monitoring for a change at the agent's computing device, or sending information about the change at the agent's computing device, or both, may be done automatically or manually. If manually, such action may be performed only upon request by the agent, approval by the agent, or both. Whether information is detected and sent any of these manners is a design choice of the company. Another design choice is not to send information on changes to the customer's computing device, but only to allow the agent to send messages to the customer via the customer's computing device.

Information may be sent by the agent's computing device to the customer's computing device as a message which appears on the customer's computing device screen, or as information which is inserted into a form, or as a web address which is inserted into the customer's browser, or as a cookie which is inserted into the customer's computing device.

Steps 103A, 103B, and 104 are optional in the agent's computing device. As mentioned above, the preferred way of communicating with the customer may be via message, in which case the agent's computing device need only have messaging capability, which may be by any desired messaging software, including but not limited to “instant messaging” software or “chatting” software.

After step 104, or after step 103B if there is no change, decision 106 is executed to determine whether web collaboration is still enabled. If so, then a return is made to step 105A. If not, then web collaboration is ended 107.

The agent's computing device checks for information from the customer's computing device, and changes at the agent's computing device, at a polling rate. In the preferred embodiment the polling rate is approximately the same as for a customer's computing device. However, this is a design choice, and the agent's computing device and the customer's computing device may poll at different rates or the same rates, subject to the considerations mentioned above.

Thus, from a review of FIGS. 1-3, it will be understood that the present invention monitors for changes at the customer's computing device and sends those changes to the agent's computing device, whereby they are presented to the agent or acted upon. Further, if desired, the present invention may monitor for changes at the agent's computing device and send those changes to the customer's computing device. This transfer of information continues until web collaboration is terminated.

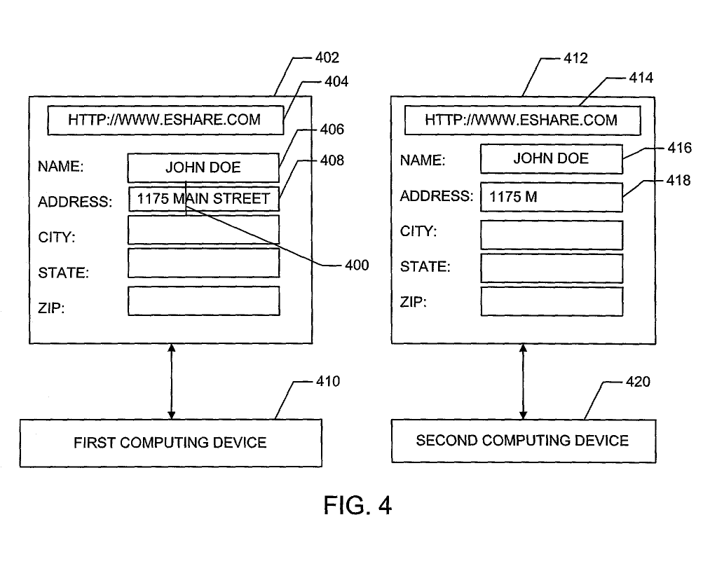

FIG. 4 is an illustration of the polling operation. The first computing device 410 is the computing device which is polled for a change in activity, such as the customer's computing device. The display 402 indicates the web page, including a form, currently being viewed by the customer. The customer has gone to a new web site, and has started completing a form present on that web page. The separation point between the contents of the display immediately before the polling operation, and the contents of the display after the polling operation but before the next polling operation, is indicated by the polling point line 400. Text entered before polling point 400 is the web address 404, the text entered in the form in field 406, and the text entered in the form in the first half of field 408. Text entered after polling point 400 in field 408 is the remainder of the user's address. For convenience of illustration, the polling rate is presumed to be very slow. In practice, the polling rate would only allow a few characters to be typed before a next polling occurred. Not shown is the transfer of the cookie. Typically, when the first computing device goes to a new web site, a cookie will be returned from that new web site and stored on the first computing device. The polling operation also retrieves and sends that cookie to the second computing device.

After the polling operation 400 on first computing device 410 has been performed the information has been sent to the second computing device 420. The information is then automatically displayed or approved for display by the person at the second computing device 420. In the example shown, receipt of the new web address would cause the agent's computing device to go that web site. Further, the new cookie would already be present on the agent's computing device. Thus, when the agent's computing device goes to the new web site, the new web site would pull the cookie and treat the agent's computing device as if a “refresh” operation were being performed. Thus, the server at the new web site would send the same form to the agent as is already present on the display of the user's computing device. Then, the information entered on the form by the user, up to the polling point, would appear on the form on the agent's computing device. Thus, web address 414 is the same as that on the first computing device 404, as well as the name field 416. However, the address field 418 only contains the text present on the display 412 of the first computing device 410 at the time of the polling operation 400. The information entered after this polling point will be picked up at the next polling point. Thus, the display 412 at the second computing device 420 contains the same information as is present on the display 402 of the first computing device 410 at the time of the polling operation, just delayed by the polling interval time. Therefore, the agent is seeing the same web page and information as the customer.

As indicated above, this process can also be performed on the agent's computing device, so that the agent can enter information, which will then appear on the display of the customer.

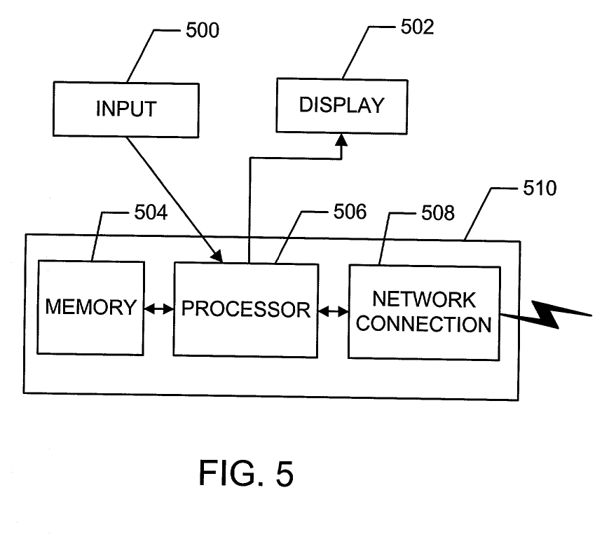

FIG. 5 is a block diagram of a computing device in accordance with the present invention. Input device 500 is preferably a keyboard and a mouse but may consist of any input desired and appropriate input device, such as a trackpad or trackball, touch-sensitive screen, voice recognition software, etc. This input 500 device is coupled to processor 506.

Display device 502 is preferably a CRT or LED monitor but may be any appropriate or desired device which can present information to the user, such as software for converting text to speech, a device which converts text to Braille for tactile sensing, etc. This display device 502 is coupled to the processor 506.

The computing device 510 includes the processor 506 and a memory 504 which is coupled to the processor 506. Processor 506 is coupled to the network connection 508 which is connected with the Internet in the exemplary embodiment. However, as mentioned above, this connection may be to or via any network or communications system which allows the desired communications between the computing devices.

The collaboration provided by the present invention thus enables users at a first computing device and a second computing device to browse the Internet in unison. Typically, the second computing device is an agent's computing device of a company, and the first computing device belongs to a customer receiving assistance from the agent. However, the user at one computing device, such as the first computing device, may be a trainee and the user at another computing device, such as the second computing device, may be a trainer. In this case the present invention provides for remote training of an employee as the trainer could see, comment on, and/or correct, the trainee's input as it occurred.

Typically, the user at the first computing device will “lead” the web collaboration. That is, the user, such as a customer or trainee, at the first computing device will take the first action, and the user, such as the agent or trainer, at the second computing device will view, comment on, and/or correct the first action. However, this role could be reversed if desired for expediency or other reasons. That is, the user at the second computing device could instruct the user at the first computing device as to what action to take and then verify that the user at the first computing device performed the action correctly, or the user at the second computing device could take the action so that the user at the first computing device could actually see how the action is performed, rather than just being told how to do it.

Although the present invention has been described with particularity, it will be appreciated that changes and modifications may be made without departing from the spirit or scope of the invention.

What is claimed is:

1. A method of operating a first computing device and a second computing device, said method comprising the steps of:
connecting a first computing device and a second computing device;
monitoring for predetermined changes at said first computing device;
sending to said second computing device information regarding said predetermined changes at said first computing device;
receiving said information at said second computing device, and implementing said information at said second computing device.

2. The method of claim 1 and, prior to said step of monitoring, further comprising the step of:
transferring a program to said first computing device, said program being for monitoring for said predetermined changes at said first computing device.

3. The method of claim 1 wherein said step of monitoring for predetermined changes at said first computing device comprises monitoring for changes relating to a predetermined program operating on said first computing device.

4. The method of claim 1 wherein said step of monitoring for predetermined changes at said first computing device comprises monitoring for changes relating to a web browser program operating on said first computing device.

5. The method of claim 1 wherein said step of monitoring for predetermined changes at said first computing device comprises monitoring for a change in an Internet web address used by a web browser program operating on said first computing device.

6. The method of claim 1 wherein said step of monitoring for predetermined changes at said first computing device comprises monitoring for user input to a form displayed by a web browser program operating on said first computing device.

7. The method of claim 1 wherein said step of monitoring for predetermined changes at said first computing device comprises monitoring for a new cookie received by a web browser program operating on said first computing device.

8. The method of claim 1 wherein said step of implementing said information at said second computing device comprises entering said information into a predetermined program operating on said second computing device.

9. The method of claim 1 wherein said step of implementing said information at said second computing device comprises entering said information into a web browser program operating on said second computing device.

10. The method of claim 1 wherein said step of implementing said information at said second computing device comprises entering said information into the Internet web address portion of a web browser program operating on said second computing device.

11. The method of claim 1 wherein said step of implementing said information at said second computing device comprises entering said information into a form displayed by a web browser program operating on said second computing device.

12. The method of claim 1 wherein said step of implementing said information at said second computing device comprises storing said a new cookie in a file related to a web browser program operating on said second computing device.

13. The method of claim 1 wherein said step of monitoring for predetermined changes at said first computing device comprises inspecting said first computing device for said predetermined changes at predetermined intervals.

14. The method of claim 1 and, after said step of receiving said information at said second computing device, further comprising the step of presenting said information to a user at said second computing device for approval and, if said user approves said information, then performing said step of implement said information.

15. The method of claim 1 wherein said step of connecting said first computing device and said second computing device comprises communicating through a server that interacts with said first computing device.

16. The method of claim 1 wherein said step of connecting said first computing device and said second computing device comprises communicating through a server that interacts with said second computing device.

17. The method of claim 1 wherein said step of connecting said first computing device and said second computing device comprises communicating through a server that interacts with said first computing device and said second computing device.

18. A method of operating a first computing device, said method comprising the steps of:
connecting said first computing device to a second computing device;
monitoring for predetermined changes at said first computing device; and
sending information regarding said predetermined changes to said second computing device.

19. The method of claim 18 and, prior to said step of monitoring, further comprising the step of:
transferring a program to said first computing device, said program being for monitoring for said predetermined changes at said first computing device.

20. The method of claim 18 wherein said step of monitoring for predetermined changes at said first computing device comprises monitoring for changes relating to a predetermined program operating on said first computing device.

21. The method of claim 18 wherein said step of monitoring for predetermined changes at said first computing device comprises monitoring for changes relating to a web browser program operating on said first computing device.

22. The method of claim 18 wherein said step of monitoring for predetermined changes at said first computing device comprises monitoring for a change in an Internet web address used by a web browser program operating on said first computing device.

23. The method of claim 18 wherein said step of monitoring for predetermined changes at said first computing device comprises monitoring for user input to a form displayed by a web browser program operating on said first computing device.

24. The method of claim 18 wherein said step of monitoring for predetermined changes at said first computing device comprises monitoring for a new cookie received by a web browser program operating on said first computing device.

25. The method of claim 18 wherein said step of monitoring for predetermined changes at said first computing device comprises inspecting said first computing device for said predetermined changes at predetermined intervals.

26. A method of operating a first computing device, said method comprising the steps of:
connecting a first computing device to a second computing device;
monitoring for predetermined changes at said first computing device;
sending information regarding said predetermined changes to said second computing device;
receiving information regarding predetermined changes at said second computing device, and
implementing, at said first computing device, said information regarding said predetermined changes at said second computing device.

27. The method of claim 26 and, prior to said step of monitoring, further comprising the step of:
transferring a program to said first computing device, said program being for monitoring for said predetermined changes at said first computing device.

28. The method of claim 26 wherein said step of monitoring for predetermined changes at said first computing device comprises monitoring for changes relating to a predetermined program operating on said first computing device.

29. The method of claim 26 wherein said step of monitoring for predetermined changes at said first computing device comprises monitoring for changes relating to a web browser program operating on said first computing device.

30. The method of claim 26 wherein said step of monitoring for predetermined changes at said first computing device comprises monitoring for a change in an Internet web address used by a web browser program operating on said first computing device.

31. The method of claim 26 wherein said step of monitoring for predetermined changes at said first computing device comprises monitoring for user input to a form displayed by a web browser program operating on said first computing device.

32. The method of claim 26 wherein said step of monitoring for predetermined changes at said first computing device comprises monitoring for a new cookie received by a web browser program operating on said first computing device.

33. The method of claim 26 wherein said step of monitoring for predetermined changes at said first computing device comprises inspecting said first computing device for said predetermined changes at predetermined intervals.

34. The method of claim 26 wherein said step of implementing said information at said first computing device comprises entering said information into a predetermined program operating on said first computing device.

35. The method of claim 26 wherein said step of implementing said information at said first computing device comprises entering said information into a web browser program operating on first computing device.

36. The method of claim 26 wherein said step of implementing said information at said first computing device comprises entering said information into the Internet web address portion of a web browser program operating on said first computing device.

37. The method of claim 26 wherein said step of implementing said information at said first computing device comprises entering said information into a form displayed by a web browser program operating on said first computing device.

38. The method of claim 26 wherein said step of implementing said information at said first computing device comprises storing said a new cookie in a file related to a web browser program operating on said first computing device.

39. A method of operating a first computing device, said method comprising the steps of:
connecting a first computing device to a second computing device;
receiving, at said first computing device, information regarding predetermined changes at said second computing device, and
implementing, at said first computing device, said information regarding said predetermined changes at said second computing device.

40. The method of claim 39 wherein said step of implementing said information at said first computing device comprises entering said information into a predetermined program operating on said first computing device.

41. The method of claim 39 wherein said step of implementing said information at said first computing device comprises entering said information into a web browser program operating on first computing device.

42. The method of claim 39 wherein said step of implementing said information at said first computing device comprises entering said information into the Internet web address portion of a web browser program operating on said first computing device.

43. The method of claim 39 wherein said step of implementing said information at said first computing device comprises entering said information into a form displayed by a web browser program operating on said first computing device.

44. The method of claim 39 wherein said step of implementing said information at said first computing device comprises storing said a new cookie in a file related to a web browser program operating on said first computing device.

45. A method of operating a first computing device, said method comprising the steps of:
connecting a first computing device to a second computing device;
monitoring for predetermined changes at said first computing device;
sending information regarding said predetermined changes to said second computing device;
receiving information regarding predetermined changes at said second computing device,
comparing said information regarding said predetermined changes at said first computing device with said information regarding said predetermined changes at said second computing device;
implementing, at said first computing device, said information regarding said predetermined changes at said second computing device which is different from said information regarding said predetermined changes at said first computing device.

46. The method of claim 45 and, prior to said step of monitoring, further comprising the step of:
transferring a program to said first computing device, said program being for monitoring for said predetermined changes at said first computing device.

47. The method of claim 45 wherein said step of monitoring for predetermined changes at said first computing device comprises monitoring for changes relating to a predetermined program operating on said first computing device.

48. The method of claim 45 wherein said step of monitoring for predetermined changes at said first computing device comprises monitoring for changes relating to a web browser program operating on said first computing device.

49. The method of claim 45 wherein said step of monitoring for predetermined changes at said first computing device comprises monitoring for a change in an Internet web address used by a web browser program operating on said first computing device.

50. The method of claim 45 wherein said step of monitoring for predetermined changes at said first computing device comprises monitoring for user input to a form displayed by a web browser program operating on said first computing device.

51. The method of claim 45 wherein said step of monitoring for predetermined changes at said first computing device comprises monitoring for a new cookie received by a web browser program operating on said first computing device.

52. The method of claim 45 wherein said step of monitoring for predetermined changes at said first computing device comprises inspecting said first computing device for said predetermined changes at predetermined intervals.

53. The method of claim 45 wherein said step of implementing said information at said first computing device comprises entering said information into a predetermined program operating on said first computing device.

54. The method of claim 45 wherein said step of implementing said information at said first computing device comprises entering said information into a web browser program operating on first computing device.

55. The method of claim 45 wherein said step of implementing said information at said first computing device comprises entering said information into the Internet web address portion of a web browser program operating on said first computing device.

56. The method of claim 45 wherein said step of implementing said information at said first computing device comprises entering said information into a form displayed by a web browser program operating on said first computing device.

57. The method of claim 45 wherein said step of implementing said information at said first computing device comprises storing said a new cookie in a file related to a web browser program operating on said first computing device.
